(19) United States
(12) Patent Application Publication
(10) Pub. No.: US 2009/0013391 A1
(43) Pub. Date: Jan. 8, 2009

(54) Identification System and Method

(76) Inventor: Johannes Ernst, Sunnyvale, CA (US)

Correspondence Address: Johannes Ernst, 668 Starbush Dr., Sunnyvale, CA, 94086, US

(21) Appl. No.: 12/139,257

(22) Filed: Jun. 13, 2008

Related U.S. Application Data
(60) Provisional application No. 60/947,905, filed on Jul. 3, 2007.

(51) Int. Cl. H04L 9/32

(52) U.S. Cl. 726/6; 726/7

(57) ABSTRACT

A system and a method is disclosed for securely identifying human and non-human actors. A computer implemented system and a method is also disclosed for securely identifying human and non-human actors.

### PRIORITY CLAIM

This application claims priority under 35 USC 119(e) to U.S. Patent Application Ser. No. 60/947,905 filed on Jul. 3, 2007 entitled “Identification System and Method” which is incorporated herein by reference.

### FIELD OF THE INVENTION

The invention relates generally to a system and method for identification, and in particular to a computer-implemented system and method for identification.

### COPYRIGHT NOTICE

Copyright 2007-2008 by Johannes Ernst. The copyright owner has no objection to facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

Ensuring, with high confidence, that agents are who they say they are—in the physical world, or in cyberspace—has always been difficult. Agents may be individuals, groups, organizations, legal entities, physical objects, electronic devices, websites, web services, software objects or many other types of entities. Because of this difficulty, security is often lower than desirable; conversely, the risk of being defrauded, off-line or on-line, is higher than desirable.

Recently, a host of new “digital identity” technologies have become available. These include technologies as diverse as biometric authentication, contextual reputation, new approaches to cryptography, identity “federation” and projects such as OpenID, LID, SAML, Higgins or Microsoft CardSpace. It can be expected that innovation in this area will continue.

However, the usefulness of these technologies (collectively called “identity technologies” in this document) has been impeded by certain problems that make it infeasible to apply these technologies as broadly as would be desirable for security, cost and convenience reasons: all of the identity technologies listed above make the assumption that in order for a B to determine whether an agent claiming to be A is indeed A, they rely on the assertion of a third party C that, for some reason that is immaterial to this discussion, has better knowledge than B about whether an agent claiming to be A is indeed A. B is often called a “Relying Party”, relying on an Assertion (often but not always employing cryptographic methods) of an “Identity Provider” C about an Agent A. (This may include the special case where A acts as their own Identity Provider C, and the special case where several parties work together to play the role of Identity Provider C.) Many parties have sprung up in recent years wishing to play the role of C.

This creates a problem for any B: which of the many C's should B trust to make correct assertions about A's identity for a given purpose?

As it is apparent to those skilled in the art, this class of problems exists irrespective of the specific identity technology or protocol in use, and very likely will also exist for future identity technologies that have not been invented yet. Specifically it exists for OpenID, where OpenID Providers may be hostile; for information cards (such as implemented by Microsoft CardSpace and similar products), where managed card providers, individuals asserting their own identity, or identity selectors may be hostile; it even exists where username/password combinations are used as credentials and an entity storing, transporting or remembering them may be hostile; also for biometric or other strong forms of authentication, where the entity performing the authentication may be hostile and provide an assertion that does not correspond to its own best judgment.

Note that in this discussion, the term “hostile” does not necessarily need to refer to an intentionally malicious act; an Identity Provider C may be hostile simply by virtue of being operated sloppily and insecurely, or by having been compromised by a successful attacker.

Note that the term “identification” is used broadly this document: it includes enabling B to be confident B is currently interacting with the same A as B did at some previous occasion; it includes B obtaining information about an A (such as zip code or medical history); it includes B determining that A is a member of a group with or without being able to tell which member, and others known in the art.

From the perspective of a given B, this is a formidable problem. For example, B may be an on-line merchant selling widgets. B's expertise may lie in the production of widgets, their marketing, distribution and sale. It thus has the goal to securely interact with, e.g. sell to, as many A's as possible, in order to maximize revenue. This means it would like to rely on as many C's as possible to evaluate A's as it cannot assume that all possible A's are well-known to the same trustworthy C. But themselves, B's often do not have the ability to tell a “trustworthy” C from a less trustworthy one, or even from an outright fraudster. (Even if some other party may have that information.)

By being unable to tell trustworthy C's from less trustworthy C's or attackers, B cannot effectively deploy the identity technologies known in the art today, and thus cannot reliably identify A's.

Also, given this problem, it would clearly be a very promising avenue for an attacker to become a “trustworthy” C that asserts a falsehood about one or many A's whenever it may choose in order to defraud B. So each B needs to vet those C's well whose assertions it is willing to accept.

Current practice in the art knows three main approaches to address this problem:

(1) Each B can establish and maintain a list of C's whose assertions it is willing to accept (called a “white list”).

(2) Each B can establish and maintain a list of C's whose assertions it is never willing to accept (called a “black list”).

(3) Each B can enter into contractual agreements (perhaps with specified penalties in case of non-performance) with a selected set of C's. (Often known as “circle of trust”.)

While these are technically effective solutions, these solutions are known in the art not to scale from a small number of B's and C's (low teens, for example) to the general case (such as to the entire internet): the costs and operational overhead involved in categorizing a sufficient number of C's (including, for example, background checks, security audits, intrusion monitoring, review of legal regimes in different jurisdictions etc.) and keeping the categorization current make these approaches all but cost-prohibitive for most B's. In fact, simply just deploying available identity technologies presents substantial challenges for many B's as: their core competency, and business focus, is more likely the selling of widgets than the details of identity technologies.

It is towards this set of problems that they present invention is directed.

### BRIEF SUMMARY OF THE INVENTION

The present invention enables a Relying Party B to securely identify a plurality of Agents A by delegating to an Identification System D the evaluation of Assertions about the Agents A received from a plurality of Identity Providers C.

### BRIEF DESCRIPTION OF THE DRAWINGS

FIG. 1 shows a preferred embodiment of the present invention in a protocol-neutral fashion.

FIG. 2 shows a preferred embodiment of the present invention that employs the OpenID protocol.

FIG. 3 shows a preferred embodiment of the present invention that employs the CardSpace protocol.

FIG. 4 shows a subset of the HTML used by a web-enabled Relying Party B aspect of the present invention to challenge Individual A in one example, web-enabled embodiment of the present invention that supports both OpenID and CardSpace.

FIG. 5 shows a preferred embodiment of the Relying Party aspect of the present invention.

FIG. 6 shows an embodiment of the Identification System component of the present invention that supports the use of cryptography.

FIG. 7 shows an embodiment of the Identification System component of the present invention that evaluates Identity Provider Facts.

FIG. 8 shows a preferred embodiment of the Identification System component of the present invention that supports the use of cryptography and that evaluates Identity Provider Facts.

FIG. 9 shows an example embodiment in a Java-like programming language of the Relying Party aspect of the present invention that accepts incoming Assertions, forwards them to Identification System D, obtains the Response and takes a different action based on the Response.

### DETAILED DESCRIPTION OF A PREFERRED EMBODIMENT

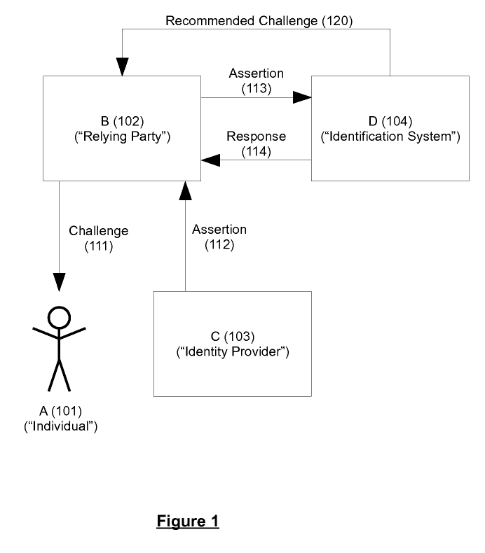

In a preferred embodiment of the present invention, shown in FIG. 1, an Individual A (101) is challenged by a Relying Party B (102) with an identification Challenge (111). In order to identify itself when challenged, Individual A (101) presents an Assertion (112) from Identity Provider C (103) to Relying Party B (102).

Relying Party B (102) had consulted with a fourth party, Identification System D (104), to present the most appropriate Challenge (111) to identify Agent A (101), and presented the Recommended Challenge (120) recommended by Identification System D (104) as Challenge (111) to Agent A (101). In an alternate embodiment, Relying Party B (102) does not consult Identification System D (104) for a Recommended Challenge (120) and puts up its own Challenge (111) instead.

Relying Party B (102) decides on the acceptability of the presented Assertion (112) by consulting with Identification System D (104). Relying Party B (102) does this by passing on the provided Assertion (112) as Assertion (113) to Identification System D (104). As it will be apparent to those skilled in the art, Relying Party B (102) may pass on the Assertion (112) either verbatim or transformed in some way (e.g. by encrypting, decrypting, adding or removing information, and the like) to Identification System D (104) without deviating from the spirit and principles of the present invention.

In turn, Identification System D (104) returns to Relying Party B (102) a Response (114) that enables Relying Party B (102) to decide whether or not to trust that the Agent is indeed Individual A (101). This decision enables Relying Party B (102) to take different courses of action, such as allowing Individual A (101) access to a resource or not.

This document uses the phrase “access to a resource” as a shorthand form of “a particular kind of access to a particular resource”. For example, a given Actor may or may not have write or read access to a particular web page.

Response (114) contains information that expresses either “recommend to trust the assertion” or “recommend to not trust the assertion”. Without deviating from the sprit and principles of the present invention, Response (114) may also include information about which reasoning was applied by Identification System D (104) when constructing the Response; information conveyed to Identification System D (104) through the incoming Assertion (113), and other information that Identification System D (103) has and that is potentially of interest to Relying Party B (102). Identification System D (104) may also include information from other sources that relate to one or more parties in this transaction (not shown).

As it will be apparent to those skilled in the art, Relying Party B (102) does not need to be able to perform the analysis of the provided Assertion (112) at all, but delegates the analysis to Identification System D (104). This has major benefits to B:
B does not need to acquire relevant expertise in the validation of assertions; for example, as many assertions make use of complex cryptography, Relying Party B does not need to know about complex cryptography; only Identification System D needs to.
The cost of being prepared to validate assertions with high confidence is incurred once (at Identification System D) for potentially many Relying Parties B that it serves.
Identification System D can establish and maintain a single database containing detailed information about Identity Providers C that can be used by Identification System D to inform the many Responses returned to many Relying Parties B. This substantially reduces the cost and complexity issues faced by Relying Parties B discussed above, as the cost needs to be incurred only once instead of N times for N Relying Parties B.
As digital identity and related technologies and protocols evolve, as new security vulnerabilities are being detected and need to be addressed, and as new digital identity and related technologies and protocols are invented and defined, only Identification System D needs to be improved or upgraded, not each Relying Party B.

As it will be apparent to those skilled in the art, without deviating from the principles and spirit of the present invention, A, B, C and D could be any kind of entity, not just a human individual or a website, including but not limited to groups, organizations, legal entities, physical objects, electronic devices, web sites, web services and software objects. Similarly, the ceremony by which A gets C to present an assertion to B on its behalf can be supported by a variety of technical and/or social protocols and is in no way limited to any particular identity protocol or identity technology such as OpenID. The specific terms “Relying Party”, “Identity Provider” and the likes are only used for explanatory reasons throughout this document; the terms are not meant to be limited to the responsibilities outlined in particular protocol definition documents.

As it will be apparent to those skilled in the art, Assertion (113), Response (114) and Recommended Challenge (120) may be conveyed between some or all of the parties employing a variety of different means, including one or more computer or communications networks, by direct invocation, or any other means of conveying information, without deviating from the principles and spirit of the present invention. Further, Identification System D may be physically collocated with one or more Relying Parties B, such as operating on the same computing hardware; or it may be accessed remotely as a web service over a private or public network such as the internet.

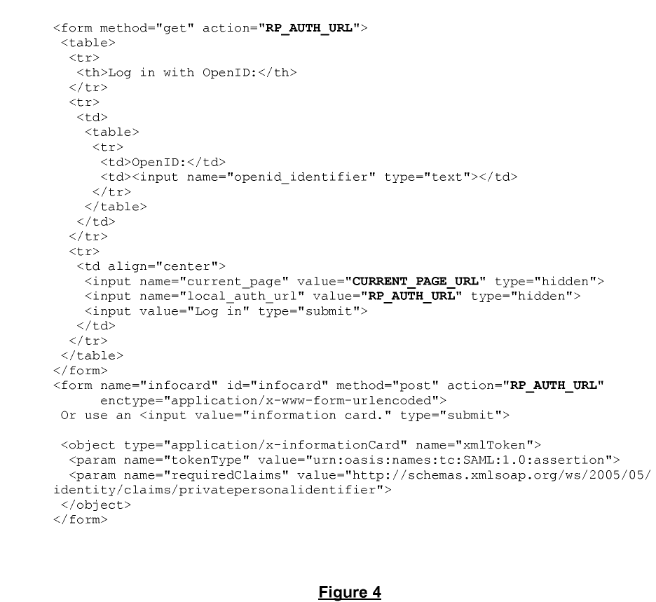

In the preferred embodiment of the present invention, Challenge (111) is represented in HTML (see also FIG. 4); Recommended Challenge (120) is represented as a JavaScript widget that, when executed, produces the HTML shown in FIG. 4; Assertion (113) is represented as the payload of an HTTP POST; Response (114) is represented as the payload on the return leg of the HTTP POST. Relying Party B (102) is a web application running on industry-standard hardware; Agent A is a human; Identification System D (104) is a web application exposing a HTTP POST-enabled service endpoint, running on industry-standard hardware; Identity Provider C (103) is a web application running on industry-standard hardware. However, as will be apparent to those skilled in the art, without deviating from the principles and spirit of the present invention, all conveyed information can be represented and conveyed in many different ways (including, if needed, using micro film via carrier pigeon, for example), and the entities storing or processing the information may be made of many different kinds of building blocks, not just hardware/software components (including, mechanical processing components, embedded devices, or humans with pencil and paper).

As will be apparent to those skilled in the art, the JavaScript widget could use AJAX technologies, plain text input, a graphical selection, voice recognition, biometrics or any other means to present the challenge. It could also use several challenges that can be considered a single compound challenge. Similarly, instead of composed of JavaScript, Recommended Challenge (120) may be provided as a data file that is interpreted by Relying Party B (102), and be rendered by Relying Party B (102) in any manner it chooses (including by deviating from the Recommended Challenge (120)), without deviating from the spirit and principles of the present invention. For example, Recommended Challenge (120) may be conveyed as an XML file, and converted into Challenge (111) expressed in medieval Latin and conveyed in a letter transported through the US Mail.

The interaction between Agent A, Relying Party B, Identity Provider C, and Identification System D may be repeated several times for the same Agent A and Relying Party B; at each repetition, the same Challenge and/or the same Identity Provider C may or may not be chosen. This enables Relying Party B to increase its own confidence with respect to Agent A as Agent A meets more than one Challenge or is vouched for by more than one Identity Provider C. Such repetition may be sequential-in-time or concurrent-in-time.

In an alternate embodiment of the present invention, Assertion (112) is directly passed as Assertion (113) by Identity Provider C (103) to Identification System D (104) instead of being indirectly conveyed by Relying Party B (102).

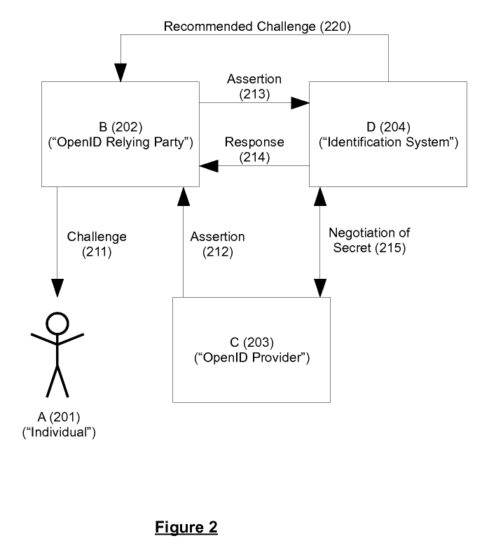

In one preferred embodiment of the present invention, the OpenID protocol is employed. This is shown in more detail in FIG. 2.

In this embodiment, OpenID Relying Party B (202) is a web application operating on industry-standard hardware that accepts OpenID Assertions (212) from OpenID Provider C (203), acting on behalf of Individual A (201), who was challenged with Challenge (211). Instead of the Relying Party B (202) having to first negotiate a secret with OpenID Provider C (203) according to the OpenID Authentication Protocol, and then having to validate the provided Assertion (212) itself, Identification System D (204) negotiates (215) the secret with OpenID Provider C (203), and then performs the validation of the Assertion (212) that is being forwarded as Assertion (213) by Relying Party B (202), returning the Response (214) that contains information that enables OpenID Relying Party B (202) to make a decision whether to allow Individual A (201) access to a resource or not. For simplicity of presentation, details of the OpenID protocol flow have been omitted from this discussion; it will be apparent to those skilled in the art how to use the present invention in conjunction with the standard OpenID flow. In this embodiment, Identification System D (204) offers a JavaScript widget that displays the Recommended Challenge (220) to OpenID Relying Party B (202), which Relying Party B (202) includes as a type of “login form” in one or more of its HTML pages. This JavaScript widget enables Individual A (201) to enter their OpenID identifier.

In an alternate embodiment, Identification System D (204) does not convey a Recommended Challenge (220) and Relying Party B (202) presents its own Challenge (211).

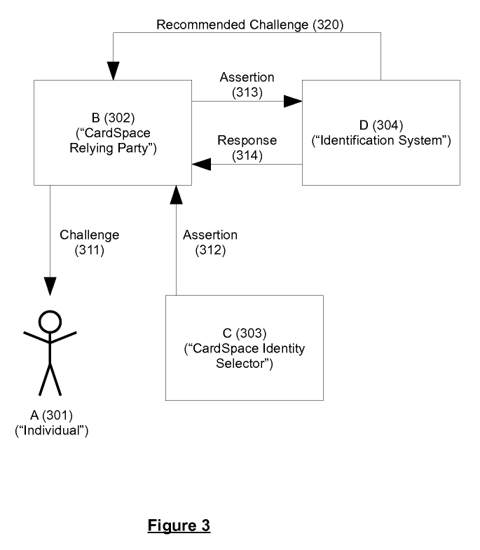

In another preferred embodiment of the present invention, CardSpace protocols are employed. This is shown in more detail in FIG. 3.

In this embodiment, Relying Party B (302) is a software application operating on industry-standard hardware that accepts a CardSpace Assertion (312) from Individual A's (301) CardSpace Identity Selector (303). Instead of Relying Party B (302) having to evaluate Assertion (312) itself, Relying Party B (302) forwards Assertion (312) as Assertion (313) to Identification System D (304), which returns Response (314). In this embodiment of the present invention, Identification System D (304) has access to the private key of Relying Party B (302). In an alternate embodiment, Relying Party B (302) decrypts incoming Assertion (312) before forwarding it as Assertion (313) to Identification System D (304), thereby reducing the risk of a compromise of Relying Party B's (302) private key.

As it will be apparent to those skilled in the art, CardSpace Identity Selector C (303) may be any other kind of identity agent or component (e.g. but not limited to a Higgins-style identity selector, whether as a rich client or hosted or embedded) without deviating from the spirit and principles of the present invention. Similarly, the particular protocols by which CardSpace Identity Selector C (303) and Relying Party B (302) communicate may be different from the ones supported in a current version of CardSpace without deviating from the spirit and principles of the present invention. Either self-asserted or managed cards or both may be used.

In an alternate embodiment, Identification System D (304) does not convey a Recommended Challenge (320) and Relying Party B (302) presents its own Challenge (311).

Examining the Relying Party B aspect of the present invention in more detail in a preferred web-enabled embodiment of the present invention, Relying Party B includes the HTML shown in FIG. 4 on its front page as Challenge in order to be able to support both the OpenID and the CardSpace protocols.

CURRENT_PAGE_URL is the URL of the current page. RP_AUTH_URL is the URL at which the Relying Party B receives the Assertion (e.g. 112 in FIG. 1, 212 in FIG. 2, 312 in FIG. 3). This embodiment accepts both OpenID and CardSpace assertions at the same URL, which has advantages with respect to supporting additional protocols, as the Relying Party B can be protocol-agnostic. In this embodiment, the HTML is generated by the execution of a JavaScript obtained from the Identification System D as a Recommended Challenge.

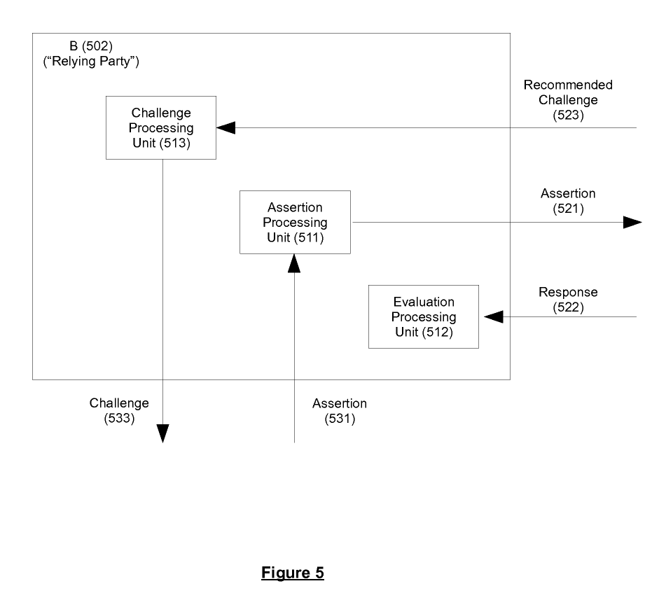

Examining the Relying Party B component of a preferred embodiment of the present invention in more detail, FIG. 5 shows the main components of Relying Party B (502): Challenge Processing Unit (513) produces Challenge (533) towards the Agent, by processing Recommended Challenge (523), which was received from an Identification System D. In the preferred embodiment of the present invention, Challenge Processing Unit (513) simply passes on Recommended Challenge (523) without change to produce Challenge (533). However, as will be apparent to those skilled in the art, Challenge Processing Unit (513) may process Recommended Challenge (523) into Challenge (533) in many different ways without deviating from the principles and spirit of the present invention. These include the graphical rendering of the Recommended Challenge (523), conversion from text to voice, adding additional criteria or removing criteria from the Recommended Challenge (523), increasing or decreasing the difficulty to meet Recommended Challenge (523), pre-filling some answers to the Challenge (533) (such as by automatically inserting the user's OpenID identifier) and many other ways.

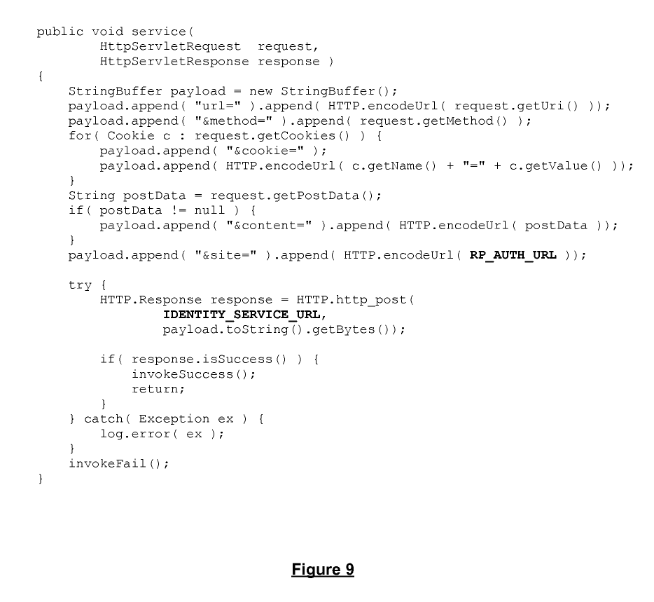

Assertion Processing Unit (511) receives incoming Assertion (531) from an Identity Provider C on behalf of Agent A, and processes it into outgoing Assertion (521), which is conveyed to an Identification System D. In the preferred embodiment of the present invention, Assertion Processing Unit (511) simply wraps the incoming Assertion (531) with a transport envelope. (See also FIG. 9.) However, as will be apparent to those skilled in the art, Assertion Processing Unit (511) may also perform more complex processing without deviating from the principles and spirit of the present invention. More complex processing may include performing cryptography operations (such as decrypting, encrypting, the creation of a digital signature, the checking of a digital signature, hashing, and others), as well as the addition or removal of information (e.g. to express the context in which the processing or the identification of the agent takes place).

Evaluation Processing Unit (512) receives Response (522) from Identification System D. Response (522) contains information that enables Evaluation Processing Unit (512) to make a decision such as whether or not to grant to Agent A access to a resource.

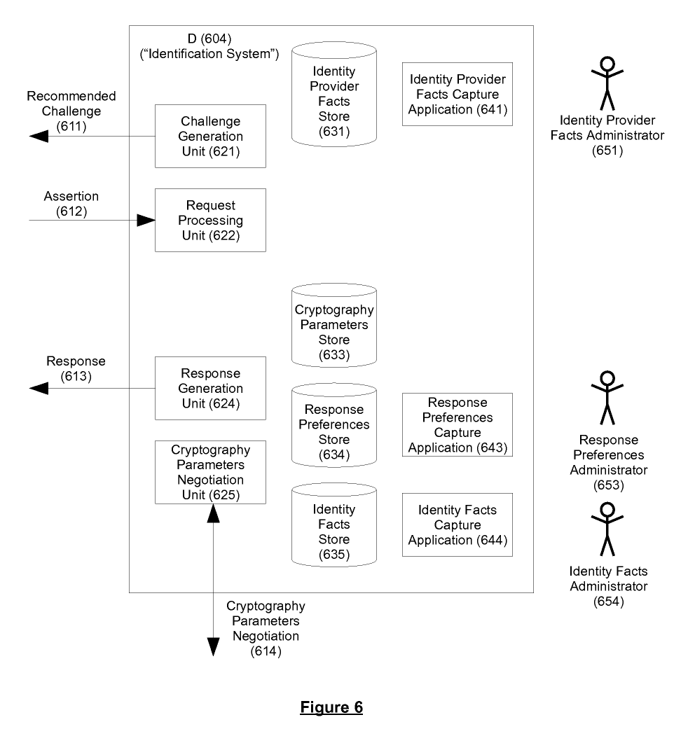

Examining the Identification System D component of one embodiment of the present invention in more detail, FIG. 6 shows the main components of Identification System D (604) in this embodiment: Upon receiving a forwarded Assertion (612), Request Processing Unit (622) interprets it. If the forwarded Assertion (612) contains cryptographic information, Request Processing Unit (622) consults with Cryptography Parameters Store (633) to obtain the appropriate cryptography parameters for processing. Depending on the cryptography approaches needed to process incoming Assertion (612), Request Processing Unit (622) may make use of one or more of a variety of processing techniques, including extracting data values, checking of digital signatures, checking of hash values, decryption and the like without deviating from the principles and spirit of the present invention.

Cryptography Parameters Store (633) stores cryptography parameters, such as cryptographic key material and secrets. If Cryptography Parameters Store (633) is asked by Request Processing Unit (622) for a cryptography parameter that it currently does not possess, it makes use of the Cryptography Parameters Negotiation Unit (625) that obtains or negotiates such parameters as needed and stores them in the Cryptography Parameters Store (633). There are many different ways to perform Cryptography Parameters Negotiation (614) with an Identity Provider C or another entity acting on its behalf, such as a key server. For example, the Cryptography Parameters Negotiation Unit (625) may perform a Diffie-Hellman key exchange over the internet as needed for OpenID. Alternatively it may obtain a digital certificate, or public key, or private key, read numbers from a one-time pad, cause a human operator to negotiate a secret word over the phone, install a certificate, or any other approach to negotiate cryptography parameters, without deviating from the spirit and principles of the present invention.

In an embodiment that supports the OpenID protocol, Cryptography Parameters Store (633) stores negotiated secrets according to the OpenID Protocol. In an embodiment that supports the CardSpace protocols, Cryptography Parameters Store (633) stores the private SSL key of the Relying Party B on whose behalf the Identification System D (604) evaluates the Assertion (612).

In an alternate embodiment of the present invention, Identification System D (604) does not perform cryptography operations; instead, Relying Party B does all cryptography processing itself. In this alternate embodiment, the cryptography functions of Request Processing Unit (622), Cryptography Parameters Store (633) and (if needed) Cryptography Negotiation Unit (625) are collocated with or under the same control as the Relying Party B, and not part of the Identification System D (604). In this alternate embodiment, Relying Party B has more responsibilities; however, for those identity technologies (such as CardSpace) that require access to Relying Party B's private key, this allows Relying Party B to keep its private key secret from the Identification System D (604), which is desirable under some circumstances.

After Request Processing Unit (622) has performed the required processing operations, it generates a Validity Result that reflects whether or not the received Assertion (612) was valid. Processing by the Request Processing Unit (622) will generally consider criteria such as syntactic correctness of the Assertion (612), validity of a digital signature (if any), and the like, but other criteria may be employed without deviating from spirit and principles of the present invention. In one embodiment of the present invention, Validity Result is a binary value with the interpretations “Assertion valid” and “Assertion not valid”. In an alternate embodiment, it is a probabilistic value, such as a fuzzy degree of truth. In yet another embodiment, several values are annotated with conditions under which they are true, such as “if not performed from a publicly accessible WiFi access point.”

Response Generation Unit (624) processes the Validity Result into Response (613), which in turn is sent back to the Relying Party B. Processing by the Response Generation Unit (624) involves converting Validity Result into a format that can be understood by Relying Party B.

In an alternate embodiment, Response Generation Unit (624) consults with Response Preferences Store (634) to determine the format and content of the Response (613) to be sent. By storing different preferences for different Relying Parties B, this enables different Relying Parties B to obtain Responses (613) in different formats, potentially containing different qualities and quantities of information. Response Preferences Store (634) may contain a fixed set of possible response preferences; alternatively, a Response Preferences Capture Application (643) enables one or more Response Preferences Administrators (653) to edit the response preferences held in the Response Preference Store (634). This is particularly advantageous if personnel working for a Relying Party B (that is utilizing the services of Identification System D (604)) edits the content of Response Preferences Store (634) as it relates to Responses (613) sent to itself; in this manner, a Response Preferences Administrator (653) can customize the content and format of Responses (613) to the needs of its own Relying Party B. Of course, Response Preferences Administrator (653) may be human or implemented as an automated process without deviating from the principles and spirit of the present invention.

As it will be apparent to those skilled in the art, a wide variety of Responses (613) may be produced by the Response Generation Unit (624) and consumed by the Relying Party B without deviating from the principles and spirit of the present invention. Similarly, the actual syntax and format of the Response (613) employed may come from a large range of possible syntaxes, including HTTP response codes, XML content, statements in a logical expressing language, prose, encrypted or not, digitally signed or not etc.

In an alternate embodiment, Assertion (612) also contains information about response preferences, which are used by Response Generation Unit (624) instead of those held by Response Preferences Store (634).

In yet another embodiment, the same result is accomplished by the Identification System (604) offering a plurality of incoming communication endpoints for incoming Assertions (612), each of which corresponds to a different response preference.

In the preferred embodiment, Assertion (612) is conveyed to Identification System D (604) as the payload of an HTTP POST operation. Response (613) consists of the return leg of the HTTP POST operation, in which the payload is comprised of a unique identifier for Agent A and the HTTP Status code expresses success or failure of the identification: the 200 status code expresses success, all others failure. Many other ways of conveying Assertions and Responses are known in the art and may be applied without deviating from the spirit and principles of the present invention.

In one embodiment, Identification System D (604) further comprises an Identity Provider Facts Store (631). The Identity Provider Facts Store (631) contains one or more facts on one or more Identity Providers C that may be of use to a Relying Party B, such as name and contact information of the organization operating the Identity Provider C, its financial position, its security policies, customer satisfaction, certifications, whether or not the Identity Provider C requires passwords, employs stronger forms of authentication (like hardware tokens, voice analysis etc.), its auditing policies, track record with respect to break-ins in the past, customer notification of compromises, the legal environment in which it operates, the reputation of the organization that operates it, contractual relationships between itself and other parties (such as, but not limited to the Relying Party B), quantity and quality of the liability it assumes in case of an incorrect response and the like.

In particular Identity Provider C's security policies may be of high interest to Relying Parties B as they have a direct bearing on the question whether or not a Relying Party B should trust an Assertion that Identity Provider C makes about an Agent A. In this embodiment, Response Generation Unit (624) augments Response (613) with some or all of the facts contained by Identity Provider Facts Store (631) on Identity Provider C. The term “facts” is used in a broad manner in this document. Specifically included are opinions about Identity Providers C that may or may not be objectively verifiable or even correct, such as “its chairman has a history of fraud”. What facts to include or exclude is an operational question for operators of Identification System D (604).

Similarly, Identification System D (604) further comprises an Identity Facts Store (635). The Identity Facts Store (635) contains one or more facts on one or more digital identities for one or more Agents that may be of interest to Relying Party B, such as whether the digital identity has been reported stolen, whether it has been used to spam, the zip code of the Individual it represents, their social network, their credit history, and so forth. In this embodiment, Response Generation Unit (624) augments Response (613) with some or all of the facts contained by Identity Facts Store (635) related to the identity referred to in Assertion (612). Again, the term “facts” is used in a broad manner, including opinions such as “is prone to start flame wars”.

Identity Provider Facts Capture Application (641) enables a human or automated Identity Provider Fact Administrator (651) to edit information about Identity Providers C and store them in Identity Provider Facts Store (63 1). Identity Facts Capture Application (644) enables a human or automated Identity Fact Administrator (654) to edit information about identities and store them in Identity Facts Store (635).

In this document, the term “edit” is meant to mean to modify information in any manner, including “create”, “change”, “add to”, “remove from” or “delete” information.

Challenge Generation Unit (621) produces a Recommended Challenge (611) when asked for by a Relying Party B. In one embodiment, the produced Recommended Challenge (611) is always the same. In an alternate embodiment, the Recommended Challenge (611) varies in ways that are unpredictable to the consumers of the Recommended Challenge (611). For example, the Challenge (611) may be to add two randomly chosen numbers.

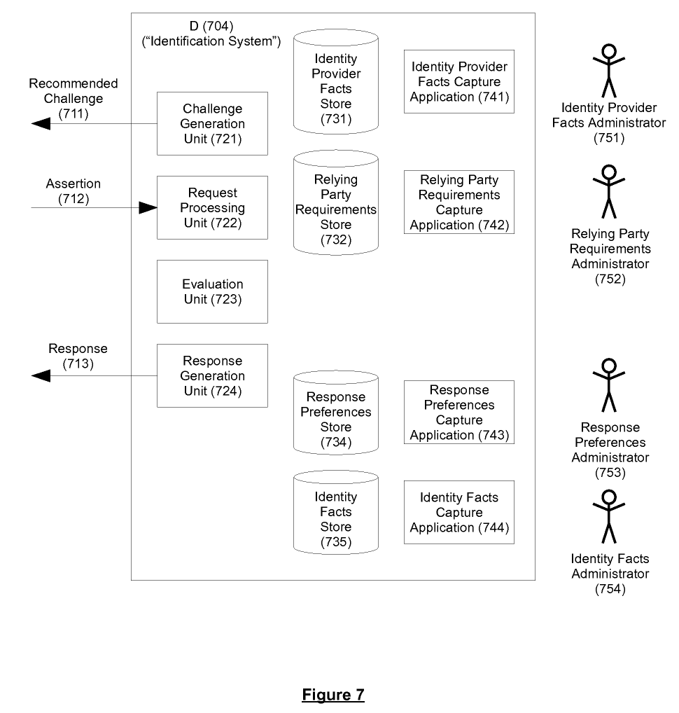

Examining the Identification System D component in an alternate embodiment of the present invention in more detail, FIG. 7 shows how incoming Assertions that do not make use of cryptography are evaluated with respect to Relying Party Requirements. Upon receiving a forwarded Assertion (712), Request Processing Unit (722) interprets it and produces a Validity Result in the manner described above; however, no cryptography processing is performed. The Validity Result is passed on to Evaluation Unit (723), which additionally obtains relying party requirements from the Relying Party Requirements Store (732) and identity provider facts from the Identity Provider Facts Store (731). It then produces an Evaluated Result, which is processed by Response Generation Unit (724) as described above (replacing Validity Result as input to Response Generation Unit (723) with Evaluated Result), potentially also utilizing Response Preferences Store (734), Response Preferences Capture Application (743), Response Preferences Administrator (753), Identity Provider Facts Store (731), Identity Facts Store (735), Identity Provider Facts Capture Application (741), Identity Provider Facts Administrator (751), Identity Facts Capture Application (744) and Identity Facts Administrator (754) in an analogous manner.

The Evaluated Result is produced by the Evaluation Unit (723) by matching what is stored in the Identity Provider Facts Store (731) about Identity Provider C from which the Assertion (712) originated, with requirements from the Relying Party B for identity providers, as stored in the Relying Party Requirements Store (732). The set of requirements stored in the Relying Party Requirements Store (732) may either be fixed, or edited by a Relying Party Requirements Administrator (752) by means of a Relying Party Requirements Capture Application (742). It is particularly advantageous if personnel working for the Relying Party B can act as Relying Party Requirements Administrator (752) with respect to the requirements of their own Relying Party B.

In an alternate embodiment, and analogously to the processing described above, Evaluation Unit (723) further considers identity facts stored in Identity Facts Store (735) about Agent A when producing the Evaluated Result.

Many relying party requirements and their combinations are known in the art and may be used with the present invention without deviating from its spirit and principles. Some examples for simple requirements are:
1. No requirements: Validity Result is the same as Evaluated Result.
2. Use a white list: Evaluated Result is only positive if Validity Result is positive and the Identity Provider issuing the Assertion has been categorized as “always approve” in Identity Provider Facts Store (731).
3. Use a black list: Evaluated Result is only positive if Validity Result is positive and the Identity Provider issuing the Assertion has not been categorized as “never approve” in Identity Provider Facts Store (731).
4. Minimum credential strength: Evaluated Result is only positive if Validity Result is positive and the Identity Provider issuing the Assertion has authenticated Agent A at least with a password that has at least 8 characters and has been changed in the last 90 days.
5. Specified credential: Evaluated Result is only positive if Validity Result is positive and the Identity Provider issuing the Assertion has authenticated Agent A with a specific credential, such as a fingerprint.
6. Liability: Evaluated Result is only positive if Validity Result is positive and the Identity Provider issuing the Assertion has made a legally enforceable promise of compensation above a specified minimum amount if it issues an incorrect Assertion about Agent A.
7. Reputation: Evaluated Result is only positive if Validity Result is positive and the identity of Agent A has not been categorized as a spammer in Identity Facts Store (735).
8. Stolen identity: Evaluated Result is only positive if Validity Result is positive and the identity of Agent A has not been categorized as stolen in Identity Facts Store (735).

In an alternate embodiment of the present invention, Response (713) also contains the rules and considerations that Evaluation Unit (723) has made use of during requirements evaluation, including confidence levels and the like.

In an alternate embodiment of the present invention, Relying Party Requirements Store (732) is not part of the Identification System D (704). Instead, Evaluation Unit (723) only considers Identity Provider Facts Store (731), Assertion (712) and, optionally, Identity Facts Store (735). The corresponding Response (713), created by Response Generation Unit (724) is then evaluated by Relying Party B according to policies that are locally defined within the Relying Party B.

Challenge Generation Unit (721) is the same as Challenge Generation Unit (621) in FIG. 6.

In an alternate embodiment, the Challenge Generation Unit (721) produces different Recommended Challenges (711) for different Relying Parties B, and consults Relying Party Requirements Store (732) for that purpose. For example, Challenge Generation Unit (721) may only generate OpenID challenges for a given Relying Party B if Relying Party Requirements Store (732) contains the requirement that Agents A have to identify themselves with an OpenID at that Relying Party B and no other options are allowed. Alternatively, it may only display the list of Identity Providers C acceptable to Relying Party B per Relying Party Requirements Store (732)

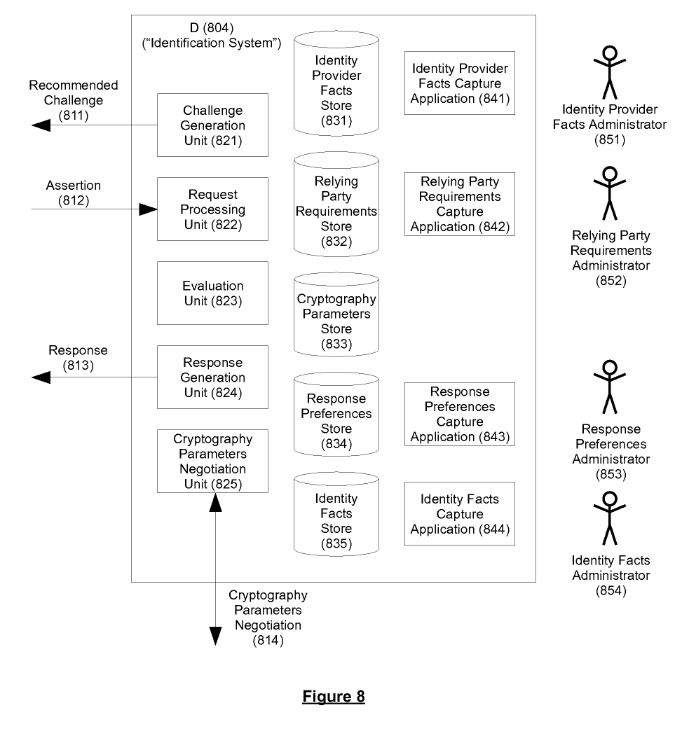

FIG. 8 shows a preferred embodiment of the Identification System D (804) component of the present invention that combines many of the concepts described in FIGS. 6 and 7.

Incoming Assertion (812) is first processed by Request Processing Unit (822) as described for FIG. 6 to produce a Validity Result, also making use of Cryptography Parameters Store (833) and Cryptography Parameters Negotiation Unit (825), which from time to time performs a Cryptography Parameters Negotiation (814). The Validity Result is passed on to Evaluation Unit (823), which obtains relying party requirements from the Relying Party Requirements Store (832), identity provider facts from the Identity Provider Facts Store (831), and identity facts from the Identity Facts Store (835). It then produces an Evaluated Result, which is processed by Response Generation Unit (824) to produce Response (813) as described for FIG. 6, potentially also utilizing Response Preferences Store (834), Response Preferences Capture Application (843), Response Preferences Administrator (853), Identity Provider Facts Store (831), Identity Facts Store (835), Identity Provider Facts Capture Application (841), Identity Provider Facts Administrator (851), Identity Facts Capture Application (844) and Identity Facts Administrator (854) in an analogous manner.

The Evaluated Result is produced by the Evaluation Unit (823) as described for FIG. 7, utilizing facts from Identity Provider Facts Store (831) and requirements from Relying Party Requirements Store (832), which may be edited by Relying Party Requirements Administrator (852) by means of a Relying Party Requirements Capture Application (842).

Challenge Generation Unit (821) is the same as Challenge Generation Unit (721) in FIG. 7.

FIG. 9 shows an aspect of a simple Relying Party B in an example web-enabled embodiment that supports both the OpenID and CardSpace protocols, employing a Java-like programming language for illustration. In this figure, RP_AUTH_URL is defined as for FIG. 4. IDENTIFICATION_SERVICE_URI is an HTTP endpoint through which Identification System D accepts incoming Assertions.

Referring back to FIG. 1, the pseudo-code shown in FIG. 9 is to be understood serving incoming HTTP requests with Assertion (112), forwarding it as Assertion (113) to the Identification System D (104) after having wrapped it into a transport envelope, receiving the Response (114) and invoking two different methods (invokeSuccess( ) and invokeFail( )), depending on the HTTP status code in the Response (114). As it will be apparent to those skilled in the art, these two methods may perform a variety of operations, including granting access to a resource, or, for example, displaying different web content to individual (101), depending on the result of the identification.

While the foregoing has been with reference to a particular embodiment of the present invention, it will be appreciated by those skilled in the art that changes in this embodiment may be made without departing from the principles and spirit of the invention, the scope of which is defined by the appended claims.

### REFERENCES

OpenID Authentication 2.0. http://openid.net/specs/openid-authentication-2_{—}0.html

David Chappell: Introducing Windows CardSpace. April 2006. http://msdn.microsoft.com/en-us/library/aa480189.aspx

What is claimed is:

1. A system and method comprising (a) a request processing unit, (b) a response generation unit, (c) a cryptography parameters negotiation unit and (d) a cryptography parameters store, where said cryptography negotiation unit from time to time exchanges information with an identity provider to establish shared cryptography parameters, where said cryptography parameters are stored in said cryptography parameters store, and further, where said request processing unit directly or indirectly receives an assertion about an agent from said identity provider and processes said assertion with said cryptography parameters to produce a validity result, and where said response generation unit produces a response that is conveyed to a relying party, said response enabling said relying party to make a decision whether or not to grant to said actor access to a resource.

2. The system and method of claim 1, further comprising a response preferences store, where response preferences are stored in said response preferences store, and where said response generation unit generates different said responses depending on said response preferences.

3. The system and method of claim 1, further comprising an identity facts store, said identity facts store containing facts about said agent, where said response generation unit augments said response with said facts about said agent.

4. The system and method of claim 1, further comprising an identity provider facts store, said identity provider facts store containing facts about said identity provider, where said response generation unit augments said response with said facts about said identity provider.

5. The system and method of claim 1, further comprising a challenge generation unit, where said challenge generation unit produces an identification challenge to be met by said agent.

6. The system and method of claim 5, further comprising an identity provider facts store, said identity provider facts store containing facts about one or more identity providers, where said challenge generation unit generates different recommended challenges depending on said facts about said one or more identity providers.

7. A system and method comprising (a) a request processing unit, (b) a response generation unit, and (c) an identity provider facts store, said identity provider facts store containing facts about an identity provider, where said request processing unit directly or indirectly receives an assertion about an agent from said identity provider and processes said assertion to produce a validity result, where said response generation unit obtains said facts about said identity provider from said identity provider facts store, and where said validity result and said facts about said identity provider are processed by said response generation unit to produce a response that is conveyed to a relying party, said response enabling said relying party to make a decision whether or not to grant to said actor access to a resource.

8. The system and method of claim 7, further comprising a response preferences store, where response preferences are stored in said response preferences store, and where said response generation unit generates different said responses depending on said response preferences.

9. The system and method of claim 7, further comprising an identity facts store, said identity facts store containing facts about said agent, where said response generation unit augments said response with said facts about said agent.

10. The system and method of claim 7, where said response generation unit augments said response with said facts about said identity provider.

11. The system and method of claim 7, further comprising (a) an evaluation unit, and (b) a relying party requirements store, said relying party requirements store containing requirements of said relying party to be met by said identity provider, where said evaluation unit determines whether or not said validity result meets said requirements of said relying party, and where said response generation unit generates a different response depending on whether said requirements were met or not.

12. The system and method of claim 7, further comprising a challenge generation unit, where said challenge generation unit produces an identification challenge to be met by said agent.

13. The system of claim 12, where said identity provider facts store contains facts about one or more identity providers, where said challenge generation unit generates different recommended challenges depending on said facts about one or more identity providers.

14. A system and method comprising (a) a request processing unit, (b) a response generation unit, (c) a cryptography parameters negotiation unit, (d) a cryptography parameters store, (e) an identity provider facts store, (f) a relying party requirements store, and (g) an evaluation unit, said relying party requirements store containing requirements of said relying party to be met by an identity provider, where said cryptography parameters negotiation unit from time to time exchanges information with said identity provider to establish shared cryptography parameters, where said cryptography parameters are stored in said cryptography parameter store, and further where said request processing unit directly or indirectly receives an assertion about an agent from said identity provider and processes said assertion with said cryptography parameters to produce a validity result, where said evaluation unit determines whether or not said validity result meets said requirements of said relying party, where said response generation unit produces a response that is conveyed to a relying party, said response enabling said relying party to make a decision whether or not to grant to said actor access to a resource, where said response generation unit generates a different response depending on whether said requirements were met or not.

15. The system and method of claim 14, further comprising a response preferences store, where response preferences are stored in said response preferences store, and where said response generation unit generates different said responses depending on said response preferences.

16. The system and method of claim 14, further comprising an identity facts store, said identity facts store containing facts about said agent, where said response generation unit augments said response with said facts about said agent.

17. The system and method of claim 14, where said response generation unit augments said response with said facts about said identity provider.

18. The system and method of claim 14, further comprising a challenge generation unit, where said challenge generation unit produces an identification challenge to be met by said agent.

19. The system and method of claim 18, where said challenge generation unit generates different recommended challenges depending on said facts about said one or more identity providers.

20. A system and method comprising (a) an assertion processing unit, and (b) an evaluation processing unit, where said assertion processing unit receives an assertion from an identity provider about an agent, where said assertion processing unit processes said received assertion to produce a produced assertion, and conveys said produced assertion to an identification system, and where said evaluation processing unit receives a response from said identification system and processes it to produce a decision whether or not to grant to said actor access to a resource.

21. The system and method of claim 20, further comprising a challenge processing unit, where said challenge processing unit receives a recommended challenge from a challenge production system, where said challenge processing unit processes said recommended challenge into the actual challenge, and where said system conveys said actual challenge to said agent.
